(19) United States
(12) Patent Application Publication
(10) Pub. No.: US 2012/0273251 A1
(43) Pub. Date: Nov. 1, 2012

(54) LAN CABLE WITH MIXED PEI AND FRPP INSULATION FOR PRIMARY CONDUCTORS

(76) Inventors: Paul Kroushl, Lancaster, PA (US); Thierry Auvray, Lancaster, PA (US)

(21) Appl. No.: 13/097,238

(22) Filed: Apr. 29, 2011

(51) Int. Cl. H01B 7/295

(52) U.S. Cl. 174/114 R

(57) ABSTRACT

A communications cable has a jacket and a plurality of twisted pairs, each twisted pair having two insulated conductors twisted around one another. At least one twisted pair uses a flame resistant olefin for the insulation and at least one twisted pair uses an imide polymer for the insulation.

### BACKGROUND

1. Field of the Invention

This application relates to cables. More particularly, this application relates to network cable insulation.

2. Description of Related Art

Communications cables are broadly grouped into two arrangements, fiber optic cables and metal conductor cables, each of which has their own unique set of construction parameters that affect the quality of the communication signals carried therethrough.

Regarding metal conductor cables, one typical arrangement is the LAN (Local Area Network) cable that is usually constructed of four pairs of twisted insulated copper conductors encased within a jacket. Other larger cables may employ more pairs of conductors.

In this typical four pair LAN cable construction, in addition to the outer jacket, each of the eight primary conductors are individually coated with an insulation layer. Special designs for LAN cables may include a cross-filler for better NEXT (Near End Cross Talk) performance.

In each case, aside from electrical performance considerations, there are certain mechanical performance tests that need to be met. One such crucial test is the NFPA 262 flame test, which is a standard method of testing for flame travel and smoke generation for testing wires and cables that may be installed in air-handling spaces such as building ductwork.

In this context, FEP (fluorinated Ethylene Polymer) resin, thanks to its outstanding electrical and flame performance, is a typical material choice for the LAN cable application, for use in the primary conductor insulation. Other fire resistant materials such FRPVC (Flame Resistant PVC) is used for the jacket as the balance of ruggedness versus electrical considerations are different for the outer jacket than for the primary insulation.

With respect to the use of FEP on the primary insulation however, because FEP resin is expensive and the source of supply is limited, research has focused on reducing the use of FEP by alternative materials.

In one such prior art example, U.S. Pat. No. 5,936,205 describes LAN type cable that uses a combination of FEP insulated pairs and FR olefin insulated pairs within the jacket. However, such a design still makes use of FEP.

### OBJECTS AND SUMMARY

The present arrangement addresses the problems with the prior art and provides for a LAN cable that meets the required NFPA 262 flame test, without the use of FEP.

To this end, the present arrangement provides a communications cable having a jacket and a plurality of twisted pairs, each twisted pair having two insulated conductors twisted around one another. At least one twisted pair uses a flame resistant olefin for the insulation and at least one twisted pair uses an imide polymer for the insulation.

### BRIEF DESCRIPTION OF THE DRAWINGS

The present invention can be best understood through the following description and accompanying drawings, wherein:

FIG. 1 shows an exemplary LAN cable according to the present arrangement.

### DETAILED DESCRIPTION

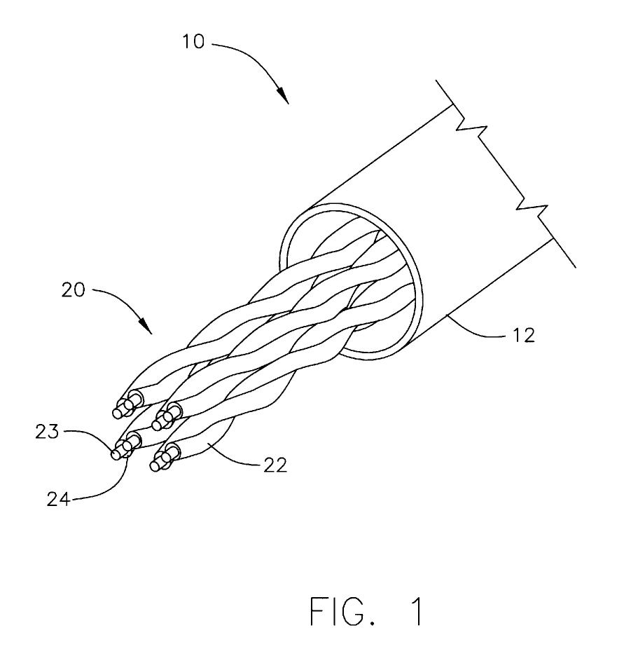

In one embodiment as illustrated in FIG. 1, a LAN (Local Area Network) cable 10 is shown. For the purposes of illustration, the salient features of the present arrangement are described in the context of a LAN cable, however, the invention is not limited in this respect. Other cables that require meeting certain flame test requirements may also employ the present technology.

As shown in FIG. 1, LAN cable 10 has a jacket 12 constructed for example from FRPVC (Flame Retardant Poly-Vinyl Chloride). Within jacket 12 there are four twisted pairs 20. Each twisted pair is formed of two primary conductors 22 twisted around one another. As shown in FIG. 1 primary conductors 22 are typically made from a copper wire conductor 23 covered with an insulation layer 24.

In the present arrangement, the polymer material used for insulation layers 24 on one twisted pair 20 is different from the polymer material used on at least another insulation layer 24 of the other twisted pairs 20 within cable 10.

In one example, insulation layer 24 on three twisted pairs 20 are made from a flame resistant olefin composition, preferably, FRPP (Flame Resistant Poly Propylene) and the other insulation layer 24 on the remaining twisted pair 20 is made from a flame resistant imide polymer, such as PEI (polyetherimide).

In another example, insulation layer 24 on two twisted pairs 20 are made from a flame resistant olefin composition, preferably, FRPP (Flame Resistant Poly Propylene) and the other two insulation layers 24 on the remaining two twisted pairs 20 are made from a flame resistant imide polymer, such as PEI (polyetherimide).

Flame Resistant Polyolefins, and in particular FRPP is significantly less expensive than either the normal prior art FEP and even the above described PEI. However, although it is flame/smoke resistant, it is not as flame smoke resistant as either FEP or PEI.

PEI has excellent flame and smoke performance. However, at tends to be stiffer resulting in less cable flexibility and its dielectric constant is higher, which means the velocity of signal propagation through PET insulated conductors is slower than through conductors insulated by FRPP. On the other hand, signal dissipation factor for PEI is lower than that of FRPP, which results in less signal attenuation.

In another embodiment, the present arrangement contemplates the use of other polymers of comparable flame resistance and electrical performance to PEI, including polyether sulfone, polyphenylene oxide, or combinations thereof with each other or with PEI.

It is noted that in order to improve metal release, processibility, aging, or flame and smoke performance, the PEI may contain organic and/or inorganic additives. In one example, the PET may be a copolymer of polyetherimide (PEI) and siloxane.

Based on these combined factors, according to one arrangement, as discussed above the insulation on two or three twisted pairs 20 are made from FRPP which has good electrical properties and good mechanical properties while providing a low cost solution to provide FR insulation on primary conductors 22. In order to provide improved smoke/fire resistance, one or two pairs 20 of primary conductors 22 are insulated with PET. This adds very high fire resistance with the result that overall cable 10 is able to meet the required NFPA 262 flame test without the use of any FEP. The added stiffness from using PEI on one or two pairs 20 is offset by the flexibility of the two or three pairs 20 insulated with FRPP and thus does not significantly impair the flexibility of cable 10.

It is noted that PEI tends to have a very high level of adhesion when extruded onto a bare metal conductor such as copper conductors 23 of pairs 20. However, the adhesion is not so great as to prevent stripping of insulation layer 24 from copper conductors 23. Moreover, in one embodiment, rather than using pure PEI, the present arrangement may use a PET blended with 0.5% HDPE (High Density PolyEthylene) so as to improve metal release.

Turning to test results for the present arrangement, the above described NFPA 262 flame test is applied to cables, such as cable 10, intended for use within buildings inside of ducts, plenums, or other spaces used for environmental air distribution. Any cable used in these areas must be “plenum rated” in order to be installed without conduit. On such plenum rating test is the NFPA 262 test. In order to pass the NFPA 262 test, these cables must have outstanding resistance to flame spread and generate low levels of smoke during combustion. As noted above, this smoke spread factor is directly related to the use of insulation on cable 10, and in particular the insulation used on twisted pairs 20. Because of the need to use low smoke insulation, these plenum rated cables are the highest in cost of the three major premise data communications cable types specified by the NEC (National Electric Code).

The NFPA 262 flame test uses a test apparatus called a Steiner Tunnel. This chamber is 25′ long by 18 inches wide by 12 inches high. An 11.25 inch wide tray is loaded with a single layer of cable, such as cable 10 placed side to side against each other so that the width of the tray is filled. The cable is then exposed to a 300,000 btu flame for 20 minutes. During the course of the test, the flame must not propagate more than 5 feet, the peak smoke must not exceed a value of 0.5 (logIO/I), and the average smoke value must not exceed 0.15 (logIO/I). It is noted that logIO/I refers to the optical density where I is the intensity of light at a specified wavelength λ that has passed through a sample (transmitted light intensity) and I₀ is the intensity of the light before it enters the sample or incident light intensity (or power). If the cable is tested twice meets all three criteria after each test, it is deemed to have passed the test.

To show the effectiveness of cable 10, the arrangement of two twisted pairs 20 using FRPP and two other twisted pairs 20 using PEI (polyetherimide) were tested against both a four (4) FEP only basic sample as well as a two (2) FEP and two (2) FRPP hybrid sample. As seen in the following table 1, the present sample of cable 10 outperforms on smoke and flame spread both the FEP/FRPP hybrid sample and even the pure FEP sample.

TABLE 1

| | | TEST | PRESENT |
|---|---|---|---|
| | | SAMPLE 2 | SAMPLE |
| | TEST | FEP (2) | PEI (2) |
| | SAMPLE 1 | pairs/ | pairs/ |
| Test | FEP (4) | FRPP (2) | FRPP (2) |
| parameters | pairs | pairs | pairs |
| Flame | 2.0′ | 3.0′ | 0.5′ |
| Spread | | | |
| Peak | 0.30 | 0.37 | 0.22 |
| Smoke | | | |
| Average | 0.08 | 0.10 | 0.04 |
| Smoke | | | |

In other words, the PEI has such improved fire/smoke resistance properties, that it more than offsets the reduced fire resistance of the FRPP while only being used on two of the four twisted pairs 20 and thus maintaining the desired flexibility of cable 10. Moreover, by the complete removal of FEP, the a cable 10 is produced that has even better NFPA 262 test results while being significantly less expensive to produce. Based on these test results it is clear that an alternative design, such as the embodiment with one PEI twisted pair 20 and three twisted pairs 20 using FRPP also meets the NFPA 262 smoke test.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A communications cable, said cable comprising:
a jacket;
a plurality of twisted pairs, each twisted pair having two insulated conductors twisted around one another, wherein at least one twisted pair uses a flame resistant olefin for the insulation and where at least one twisted pair uses an imide polymer for the insulation.

2. The communication cable as claimed in claim 1, wherein said jacket is constructed of FRPVC (Flame Resistant Poly-Vinyl Chloride).

3. The communication cable as claimed in claim 1, wherein said cable has four twisted pairs within said jacket to form a LAN (Local Area Network) cable.

4. The communication cable as claimed in claim 3, where two of said twisted pairs use a flame resistant olefin for the insulation and two of said twisted pairs use an imide polymer for the insulation.

5. The communication cable as claimed in claim 4, wherein said flame resistant polyolefin is FRPP (Flame Resistant Poly Propylene) and wherein said polyimide is PEI (Po etherimide).

6. The communication cable as claimed in claim 5, wherein said PEI includes 0.5% by weight of HDPE (High Density Polyethylene).

7. The communication cable as claimed in claim 5, wherein said cable meets a passing grade on the NFPA 262 flame test.

8. The communication cable as claimed in claim 3, where three of said twisted pairs use a flame resistant olefin for the insulation and one of said twisted pairs use an imide polymer for the insulation.

9. The communication cable as claimed in claim 7, wherein said flame resistant polyolefin is FRPP (Flame Resistant Poly Propylene) and wherein said polyimide is PEI (Polyetherimide).

10. The communication cable as claimed in claim 8, wherein said PEI includes 0.5% by weight of HDPE (High Density Polyethylene).

11. The communication cable as claimed in claim 8, wherein said cable achieves a passing result in the NFPA 262 flame test.
